(19) United States
(12) Patent Application Publication
(10) Pub. No.: US 2013/0135462 A1
(43) Pub. Date: May 30, 2013

(54) OPTICAL TOUCH DEVICE AND IMAGE PROCESSING METHOD FOR OPTICAL TOUCH DEVICE

(71) Applicants: Yu-Yen Chen, New Taipei City (TW); Shou-Te Wei, New Taipei City (TW); Hsun-Hao Chang, New Taipei City (TW); Shang-Chin Su, New Taipei City (TW)

(72) Inventors: Yu-Yen Chen, New Taipei City (TW); Shou-Te Wei, New Taipei City (TW); Hsun-Hao Chang, New Taipei City (TW); Shang-Chin Su, New Taipei City (TW)

(21) Appl. No.: 13/610,805

(22) Filed: Sep. 11, 2012

(30) Foreign Application Priority Data
Nov. 30, 2011 (TW) 100143990

(51) Int. Cl. H04N 7/18; H04N 5/222

(52) U.S. Cl. 348/135; 348/333.01; 348/E07.085; 348/E05.022

(57) ABSTRACT

An optical touch device includes at least one light source, a first image capturing module, a second image capturing module and a control module. The at least one light source is disposed outside a display unit for emitting light to an object. The first image capturing module and the second image capturing module respectively capture images of an object, and a relative position between the first image capturing module and the second image capturing module can be adjusted. The control module is coupled to the first image capturing module and the second image capturing module for calculating a coordinate value of the object according to the images of the object captured by the first image capturing module and the second image capturing module and the relative position between the first image capturing module and the second image capturing module.

### BACKGROUND OF THE INVENTION

1. Field of the Invention

The present invention relates to an optical touch device, and more particularly, to an optical touch device adapted to display units with different dimensions and a related image processing method.

2. Description of the Prior Art

In the modern consumer electronic products market, a portable electronic product, such as a personal digital assistant, a smart phone, a mobile phone and so on, is equipped with a touch control device as an interface for data transmission. Since consumer electronic products have become lighter, thinner, shorter, and smaller, there is no space on these products for containing a conventional input device, such as a mouse, a keyboard and so on. Furthermore, with development of tablet computers focusing on humanity design, a display with the touch control device has gradually become one of the key components in various electronic products. However, as the technology advances, a variety of touch control technologies such as a resistive type, a capacitive type, an ultrasonic type, an infrared type, an optical imaging type and so on have been developing. In consideration of technology level and cost, the above-mentioned touch control technologies have been implemented in various fields.

For example, principle of the optical imaging design is to utilize two image capturing modules located at two corners of the display for detecting a location of an object on the display. Then, the location of the object on the display is calculated by coordinate transformation. Thus, compared with the conventional resistive type or capacitive type touch device, it has advantages of high accuracy, high penetration, good stability, low damage rate and being capable of multi-touch. Especially, the optical imaging design is overwhelmingly advantageous in the large-size display market. However, when the dimension of the display in which the optical touch device is implemented, such as a computer display, is changed, the optical touch device and a light source thereof are required to be recalibrated for functioning normally. In other words, it is impossible to implement the single optical touch device in the displays with different dimensions, so as to constrain the optical touch device in manufacture.

### SUMMARY OF THE INVENTION

The present invention provides an optical touch device adapted to display units with different dimensions and an image processing method for the optical touch device for solving above drawbacks.

According to the claimed invention, an optical touch device adapted to display units with different dimensions includes at least one light source, a first image capturing module, a second image capturing module and a control module. The at least one light source is disposed outside a display unit for emitting light, so as to illuminate an object within a coordinate detecting area on the display unit. The first image capturing module is installed on a corner of the display unit for capturing an image of the object. The second image capturing module is installed on another corner of the display unit for capturing an image of the object, wherein a relative position between the first image capturing module and the second image capturing module is adjustable. The control module is coupled to the first image capturing module and the second image capturing module for calculating a coordinate value of the object according to the image of the object captured by the first image capturing module, the image of the object captured by the second image capturing module and the relative position between the first image capturing module and the second image capturing module.

According to the claimed invention, the optical touch device further includes a distance measurement module coupled to the control module for measuring a distance between the first image capturing module and the second image capturing module. The control module is for calculating the coordinate value of the object according to the image of the object captured by the first image capturing module, the image of the object captured by the second image capturing module and the distance between the first image capturing module and the second image capturing module measured by the distance measurement module.

According to the claimed invention, the control module is further for calculating the coordinate value of the object within the coordinate detecting area according to a first angle included between a line connecting the first image capturing module and the second image capturing module and a line connecting the first image capturing module and the object, a second angle included between a line connecting the first image capturing module and the second image capturing module and a line connecting the second image capturing module and the object and the distance between the first image capturing module and the second image capturing module measured by the distance measurement module.

According to the claimed invention, a first directional component of the coordinate value of the object within the coordinate detecting area is (the distance between the first image capturing module and the second image capturing module)*(tan(the second angle))/(tan(the first angle)+tan(the second angle)), and a second directional component of the coordinate value of the object within the coordinate detecting area is (the first directional component)*tan(the first angle).

According to the claimed invention, the control module is further for determining an intensity of the light emitted by the at least one light source according to the distance between the first image capturing module and the second image capturing module, a maximum distance between the first image capturing module and the second image capturing module, a minimum distance between the first image capturing module and the second image capturing module, a maximum intensity required by the first image capturing module and the second image capturing module as being located by the maximum distance therebetween and a minimum intensity required by the first image capturing module and the second image capturing module as being located by the minimum distance therebetween.

According to the claimed invention, the intensity of the light emitted by the at least one light source is (the minimum intensity)+[((the distance between the first image capturing module and the second image capturing module)−(the minimum distance))*(the maximum intensity−the minimum intensity)/(the maximum distance−the minimum distance)].

According to the claimed invention, the distance measurement module is an electronic measuring tape with two ends respectively connected to the first image capturing module and the second image capturing module.

According to the claimed invention, the distance measurement module is an optical range finder.

According to the claimed invention, an optical touch system includes a display unit and an optical touch device. A coordinate detecting area is formed on the display unit. The optical touch device is combined with the display unit and includes at least one light source, a first image capturing module, a second image capturing module and a control module. The at least one light source is disposed outside the display unit for emitting light, so as to illuminate an object within the coordinate detecting area on the display unit. The first image capturing module is installed on a corner of the display unit for capturing an image of the object. The second image capturing module is installed on another corner of the display unit for capturing an image of the object, wherein a relative position between the first image capturing module and the second image capturing module is adjustable. The control module is coupled to the first image capturing module and the second image capturing module for calculating a coordinate value of the object according to the image of the object captured by the first image capturing module, the image of the object captured by the second image capturing module and the relative position between the first image capturing module and the second image capturing module.

According to the claimed invention, an image processing method for an optical touch device includes at least one light source of the optical touch device emitting light to illuminate an object; a first image capturing module and a second image capturing module respectively capturing images of the object, wherein a relative position between the first image capturing module and the second image capturing module is adjustable; and a control module of the optical touch device calculating a coordinate value of the object according to the images of the object captured by the first image capturing module and the second image capturing module, and the relative position between the first image capturing module and the second image capturing module.

The present invention provides the optical touch device adapted to the display units with different dimensions and the image processing method. It can calculate the intensity of the light emitted by the corresponding light source and the coordinate value of the object according to the dimension of the display unit, i.e. the distance between the two image capturing modules without recalibrating the optical touch device or without utilizing another new optical touch device. As a result, the single optical touch device of the present invention can be implemented in the displays with different dimensions, so as to reduce cost of manufacture and enhance convenience of assembly.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a functional block diagram of an optical touch system according to an embodiment of the present invention.

FIG. 2 is a diagram of the optical touch system according to the embodiment of the present invention.

FIG. 3 is a diagram illustrating different relative positions between a first image capturing module and a second image capturing module according to the embodiment of the present invention.

FIG. 4 is a diagram of an object located within a coordinate detecting area according to the embodiment of the present invention.

FIG. 5 is a flowchart illustrating that the optical touch system performs an image processing method according to the embodiment of the present invention.

### DETAILED DESCRIPTION

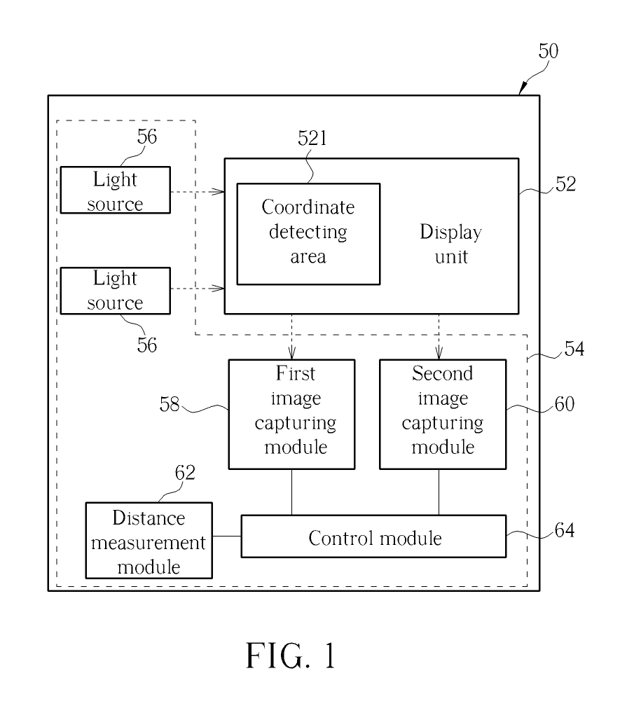

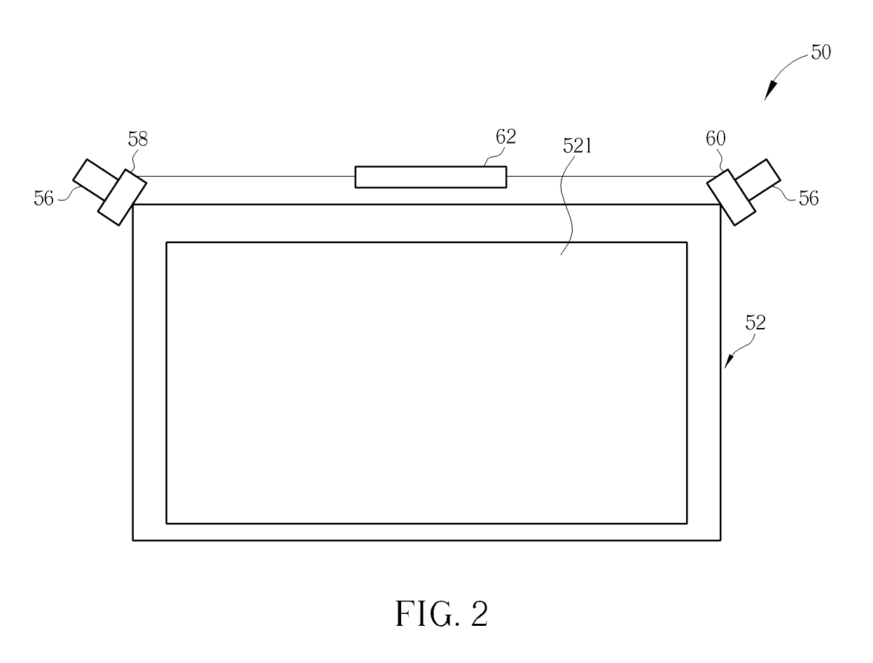

Please refer to FIG. 1 and FIG. 2. FIG. 1 is a functional block diagram of an optical touch system 50 according to an embodiment of the present invention. FIG. 2 is a diagram of the optical touch system 50 according to the embodiment of the present invention. The optical touch system 50 includes a display unit 52 whereon a coordinate detecting area 521 is formed. In this embodiment, the display unit 52 can be a display panel, an image projecting screen and so on. The optical touch system 50 further includes an optical touch device 54 combined with the display unit 52. For example, the display unit 52 and the optical touch device 54 can be integrated in a single display device, such as in a display monitor, in an All In One PC and so on. Alternatively, the optical touch device 54 can be modularized separately from the display unit 52. For example, the optical touch device 54 can be disposed inside a frame hung on the display unit 52, such that the optical touch device 54 can be installed on and detached from the display unit 52 with different dimensions. Additionally, the optical touch device 54 can be combined with the image projecting screen, that is, the optical touch device 54 is hung on a lateral side of the image projecting screen.

Furthermore, the optical touch device 54 includes at least one light source 56, a first image capturing module 58, a second image capturing module 60, a distance measurement module 62 and a control module 64. The light source 56 is disposed outside the display unit 52 for emitting light, so as to illuminate an object within the coordinate detecting area 521 on the display unit 52. In this embodiment, the light source 56 can be an infrared light emitting diode, a laser light emitting diode and so on, and there are two light sources 56 which are respectively installed on two corners outside the display unit 52. An amount and disposal positions of the light sources 56 are not limited to those mentioned in this embodiment of the present invention, and it depends on practical demands.

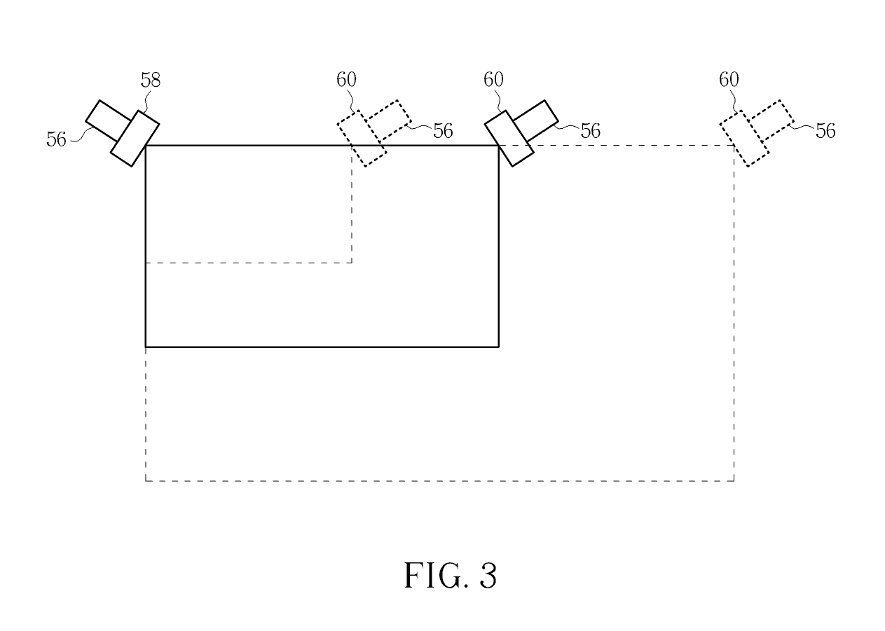

Furthermore, the first image capturing module 58 and the second image capturing module 60 are installed on two different corners of the display unit 52 for capturing images of the object. In this embodiment, the first image capturing module 58 and the second image capturing module 60 can be respectively an image sensor, such as a cameral and so on. An amount and disposal positions of the image capturing module are not limited to those mentioned in this embodiment, and it depends on practical demands. In addition, a relative position between the first image capturing module 58 and the second image capturing module 60 is adjustable. Please refer to FIG. 3. FIG. 3 is a diagram illustrating different relative positions between the first image capturing module 58 and the second image capturing module 60 according to the embodiment of the present invention. For example, one of the first image capturing module 58 and the second image capturing module 60, i.e. the first image capturing module 58, can be fixed in advance. The other one of the first image capturing module 58 and the second image capturing module 60, i.e. the second image capturing module 60, is moved relative to the first image capturing module 58, so as to adjust the relative distance between the first image capturing module 58 and the second image capturing module 60. In such a manner, the first image capturing module 58 and the second image capturing module 60 can be correspondingly installed on two different corners of the display units 52 with different dimensions.

For example, the position adjusting mechanism of the first image capturing module 58 and the second image capturing module 60 can utilize a shaft to slide the first image capturing module 58 or the second image capturing module 60, or the first image capturing module 58 and the second image capturing module 60 are respectively installed on the two corners of the display unit 52 separately. As for which one of the above-mentioned designs is adopted, it depends on practical demands. In other words, mechanisms capable of adjusting the relative position between the first image capturing module 58 and the second image capturing module 60 are within the scope of the present invention. In addition, each of the light sources 56 and the corresponding image capturing module can be modulized. In other words, positions of the light sources 56 relative to each other can be simultaneously adjusted as the relative position between the first image capturing module 58 and the second image capturing module 60 is adjusted.

Furthermore, the distance measurement module 62 is used for measuring a distance D between the first image capturing module 58 and the second image capturing module 60. For example, the distance measurement module 62 can be an electronic measuring tape with two ends respectively connected to the first image capturing module 58 and the second image capturing module 60, i.e. one end can be fixed on one of the first image capturing module 58 and the second image capturing module 60, and the other end can be fixed on the other one of the first image capturing module 58 and the second image capturing module 60. When the first image capturing module 58 and the second image capturing module 60 move relatively to change the distance D therebetween, the electronic measuring tape can be stretched, so as to generate a corresponding electronic signal to the control module 64. Alternatively, the distance measurement module 62 can be an optical range finder, which measures the distance D between the first image capturing module 58 and the second image capturing module 60 by a light beam. As mentioned above, mechanisms capable of measuring the distance between the first image capturing module 58 and the second image capturing module 60 are within the scope of the present invention.

Furthermore, the control module 64 is coupled to the first image capturing module 58, the second image capturing module 60 and the distance measurement module 62. The control module 64 calculates a coordinate value of the object within the coordinate detecting area 521 according to the image of the object captured by the first image capturing module 58, the image of the object captured by the second image capturing module 60, and the relative position between the first image capturing module 58 and the second image capturing module 60. For example, the control module 64 can be used for calculating the coordinate value of the object within the coordinate detecting area 521 according to the images respectively captured by the first image capturing module 58 and the second image capturing module 60, and the distance D between the first image capturing module 58 and the second image capturing module 60 measured by the distance measurement module 62. In addition, the control module 64 can be further used for determining an intensity P of the light emitted by the light sources 56 according to the distance D between the first image capturing module 58 and the second image capturing module 60, a maximum distance Dₘₐₓ between the first image capturing module 58 and the second image capturing module 60, a minimum distance Dₘᵢₙ between the first image capturing module 58 and the second image capturing module 60, a maximum intensity Pₘₐₓ required by the first image capturing module 58 and the second image capturing module 60 as being located by the maximum distance Dₘₐₓ therebetween and a minimum intensity Pₘᵢₙ required by the first image capturing module 58 and the second image capturing module 60 as being located by the minimum distance Dᵣₐᵢₙ therebetween. In other words, the intensity P is a function of the distance D.

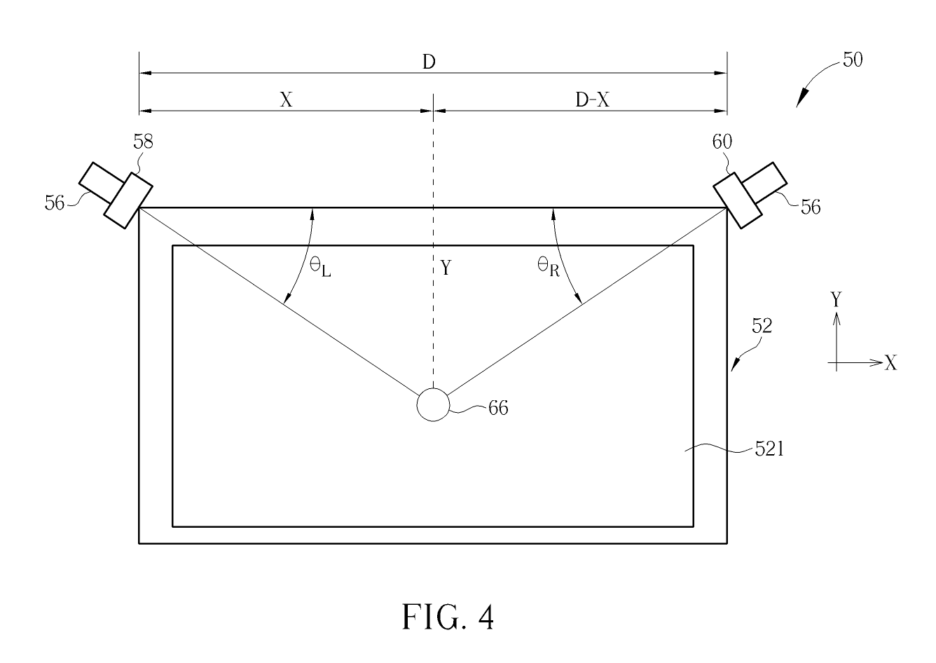

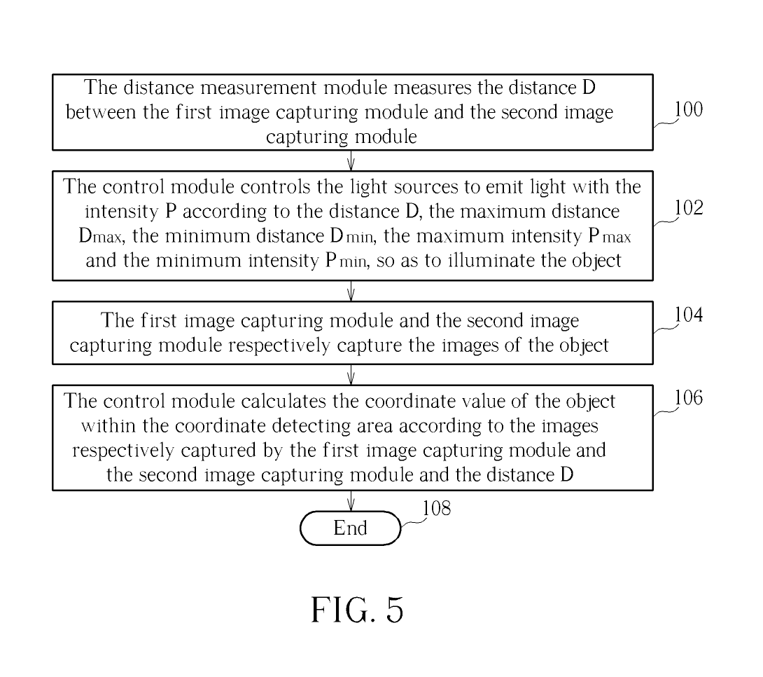

Please refer to FIG. 4 and FIG. 5. FIG. 4 is a diagram of an object 66 located within the coordinate detecting area 521 according to the embodiment of the present invention. FIG. 5 is a flowchart illustrating that the optical touch system 50 performs an image processing method according to the embodiment of the present invention. The image processing method includes steps of:

Step 100: The distance measurement module 62 measures the distance D between the first image capturing module 58 and the second image capturing module 60 after completing adjusting the relative position between the first image capturing module 58 and the second image capturing module 60.

Step 102: The control module 64 controls the light sources 56 to emit light with the intensity P according to the distance D, the maximum distance Dₘₐₓ, the minimum distance Dₘᵢₙ, the maximum intensity Pₘₐₓ and the minimum intensity Pₘᵢₙ, so as to illuminate the object 66.

Step 104: The first image capturing module 58 and the second image capturing module 60 respectively capture the images of the object 66.

Step 106: The control module 64 calculates the coordinate value of the object 66 within the coordinate detecting area 521 according to the images respectively captured by the first image capturing module 58 and the second image capturing module 60 and the distance D between the first image capturing module 58 and the second image capturing module 60.

Step 108: End.

More detailed description for the above-mentioned steps is provided as follows. At first, the relative position between the first image capturing module 58 and the second image capturing module 60 is adjustable, that is, the first image capturing module 58 and the second image capturing module 60 can be installed on the different corners of the display unit 52 corresponding to the dimension of the display unit 52, as shown in FIG. 3. When adjustment of the relative position between the first image capturing module 58 and the second image capturing module 60 is completed, the distance measurement module 62 can measure the distance D horizontally between the first image capturing module 58 and the second image capturing module 60. For example, mechanisms such as the electronic measuring tape, the optical range finder and so on can be utilized for achieving above-mentioned measurement. Afterwards, the related data are transmitted to the control module 64 for calculating the intensity P of the light sources 56 and the coordinate value of the object 66. As for the adjustment of the intensity of the light source, if the light sources 56 are too close, i.e. if the first image capturing module 58 and the second image capturing module 60 are too close, images respectively captured by the first image capturing module 58 and the second image capturing module 60 might be over-exposed. But if the light sources 56 are too far, i.e. if the first image capturing module 58 and the second image capturing module 60 are too far, the first image capturing module 58 and the second image capturing module 60 can not capture the images with sufficient intensity, resulting in indistinct images. As mentioned above, the relative position between the first image capturing module 58 and the second image capturing module 60 is required to be adjusted correspondingly for achieving a proper intensity of light according to the dimension of the display unit 52.

The maximum dimension and the minimum dimension of the optical touch system 50 to which the display unit 52 is respectively adapted are required to be defined in advance. Then, the maximum distance Dₘₐₓ between the first image capturing module 58 and the second image capturing module 60 and the minimum distance Dₘᵢₙ between the first image capturing module 58 and the second image capturing module 60 can be obtained. Afterwards, the maximum intensity Pₘₐₓ required by the first image capturing module 58 and the second image capturing module 60 as being located by the maximum distance Dₘₐₓ therebetween can be obtained experimentally, and the minimum intensity Pₘᵢₙ required by the first image capturing module 58 and the second image capturing module 60 as being located by the minimum distance Dₘᵢₙ therebetween can be obtained experimentally as well. For example, when the first image capturing module 58 and the second image capturing module 60 are located by the maximum distance Dₘₐₓ, the maximum intensity Pₘₐₓ can be defined as an maximum intensity required by the object 66 within the coordinate detecting area 521 with diagonally farthest from the first image capturing module 58 or from the second image capturing module 60. Further, when the first image capturing module 58 and the second image capturing module 60 are located by the minimum distance Dₘᵢₙ, the minimum intensity Pₘᵢₙ can be defined as an minimum intensity required by the object 66 within the coordinate detecting area 521 with diagonally farthest from the first image capturing module 58 or from the second image capturing module 60. The relationship among intensity P, the distance D, the maximum distance Dₘₐₓ, the minimum distance Dₘᵢₙ/the maximum intensity Pₘₐₓ and the minimum intensity Pₘᵢₙ can be derived as follows:

P(D)=Pₘᵢₙ+[(D−Dₘᵢₙ)*(Pₘₐₓ−Pₘᵢₙ)/(Dₘₐₓ−Dₘᵢₙ)];

In other words, it is derived by interpolation that the intensity P of light is emitted by the light sources 56 as the first image capturing module 58 and the second image capturing module 60 are located by the distance D, so as to be adapted to the display unit 52 with the corresponding dimension. Afterwards, the control module 64 can control the light sources 56 to emit light with the intensity P, so as to illuminate the object 66.

In order to achieve touch control of the optical touch system 50, a user can perform touch control operation within the coordinate detecting area 521, such as utilizing a finger, i.e. the object 66, to move within the coordinate detecting area 521. As shown in FIG. 4, when the object 66 is located within the coordinate detecting area 521, the first image capturing module 58 and the second image capturing module 60 respectively capture the images of the object 66, and the images are respectively transmitted to the control module 64. Afterwards, the control module 64 can perform image processing, such as noise reduction and so on, for the images in advance. Afterwards, performing coordinate transformation on the images after image processing. For example, the coordinate value of the object 66 within the coordinate detecting area 521 can be derived by triangulating location according to the images of the object 66 respectively captured by the first image capturing module 58 and the second image capturing module 60 and the distance D between the first image capturing module 58 and the second image capturing module 60. Finally, the coordinate value can be used by a computer host to perform the corresponding touch control operation. For example, (X,Y) is the coordinate value of the object 66 within the coordinate detecting area 521. A first angle θ_{L} is included between a line connecting the first image capturing module 58 and the second image capturing module 60, and a line connecting the first image capturing module 58 and the object 66. A second angle θ_{R} is included between a line connecting the first image capturing module 58 and the second image capturing module 60, and a line connecting the second image capturing module 60 and the object 66. The position of the object 66 for touch control can be derived by triangulating location according to the first angle θ_{L} and the second angle θ_{R} include between the images respectively captured by the first image capturing module 58 and the second image capturing module 60 and an axis X, and the distance D. The relationships are as follows:

tan θ_{L}=Y/X;

tan θ_{R}=Y/(D−X);

(D−X)*tan θ_{R}=X*tan θ_{L};

D*tan θ_{R}=X*(tan θ_{L}+tan θ_{R});

X=(D*tan θ_{R})/(tan θ_{L}+tan θ_{R});

Y=[(D*tan θ_{R})/(tan θ_{L}+tan θ_{R})]*tan θ_{L};

In such a manner, it can derive a first directional component in a first direction (X direction) and a second directional component in a second direction (Y direction) of the coordinate value (X,Y) of the object 66 within the coordinate detecting area 521, wherein the first direction (the X direction) is substantially perpendicular to the second direction (the Y direction).

Compared to the prior art, the present invention provides the optical touch device adapted to the display units with different dimensions and the image processing method. It can calculate the intensity of the light emitted by the corresponding light source and the coordinate value of the object according to the dimension of the display unit, i.e. the distance between the two image capturing modules without recalibrating the optical touch device or without utilizing another new optical touch device. As a result, the single optical touch device of the present invention can be implemented in the displays with different dimensions, so as to reduce cost of manufacture and enhance convenience of assembly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical touch device adapted to display units with different dimensions, the optical touch device comprising:
at least one light source disposed outside a display unit for emitting light, so as to illuminate an object within a coordinate detecting area on the display unit;
a first image capturing module installed on a corner of the display unit for capturing an image of the object;
a second image capturing module installed on another corner of the display unit for capturing an image of the object, wherein a relative position between the first image capturing module and the second image capturing module is adjustable; and
a control module coupled to the first image capturing module and the second image capturing module for calculating a coordinate value of the object according to the image of the object captured by the first image capturing module, the image of the object captured by the second image capturing module and the relative position between the first image capturing module and the second image capturing module.

2. The optical touch device of claim 1, further comprising:
a distance measurement module coupled to the control module for measuring a distance between the first image capturing module and the second image capturing module, the control module being for calculating the coordinate value of the object according to the image of the object captured by the first image capturing module, the image of the object captured by the second image capturing module and the distance between the first image capturing module and the second image capturing module measured by the distance measurement module.

3. The optical touch device of claim 2, wherein the control module is further for calculating the coordinate value of the object within the coordinate detecting area according to a first angle included between a line connecting the first image capturing module and the second image capturing module and a line connecting the first image capturing module and the object, a second angle included between a line connecting the first image capturing module and the second image capturing module and a line connecting the second image capturing module and the object and the distance between the first image capturing module and the second image capturing module measured by the distance measurement module.

4. The optical touch device of claim 3, wherein a first directional component of the coordinate value of the object within the coordinate detecting area is (the distance between the first image capturing module and the second image capturing module)*(tan(the second angle))/(tan(the first angle)+tan(the second angle)), and a second directional component of the coordinate value of the object within the coordinate detecting area is (the first directional component)*tan(the first angle).

5. The optical touch device of claim 2, wherein the control module is further for determining an intensity of the light emitted by the at least one light source according to the distance between the first image capturing module and the second image capturing module, a maximum distance between the first image capturing module and the second image capturing module, a minimum distance between the first image capturing module and the second image capturing module, a maximum intensity required by the first image capturing module and the second image capturing module as being located by the maximum distance therebetween and a minimum intensity required by the first image capturing module and the second image capturing module as being located by the minimum distance therebetween.

6. The optical touch device of claim 5, wherein the intensity of the light emitted by the at least one light source is (the minimum intensity)+[((the distance between the first image capturing module and the second image capturing module)−(the minimum distance))*(the maximum intensity−the minimum intensity)/(the maximum distance−the minimum distance)].

7. The optical touch device of claim 2, wherein the distance measurement module is an electronic measuring tape with two ends respectively connected to the first image capturing module and the second image capturing module.

8. The optical touch device of claim 2, wherein the distance measurement module is an optical range finder.

9. An optical touch system, comprising:
a display unit whereon a coordinate detecting area is formed; and
an optical touch device combined with the display unit, the optical touch device comprising:
at least one light source disposed outside the display unit for emitting light, so as to illuminate an object within the coordinate detecting area on the display unit;
a first image capturing module installed on a corner of the display unit for capturing an image of the object;
a second image capturing module installed on another corner of the display unit for capturing an image of the object wherein a relative position between the first image capturing module and the second image capturing module is adjustable; and
a control module coupled to the first image capturing module and the second image capturing module for calculating a coordinate value of the object according to the image of the object captured by the first image capturing module, the image of the object captured by the second image capturing module and the relative position between the first image capturing module and the second image capturing module.

10. The optical touch system of claim 9, wherein the optical touch device further comprises:
a distance measurement module coupled to the control module for measuring a distance between the first image capturing module and the second image capturing module, the control module being for calculating the coordinate value of the object according to the image of the object captured by the first image capturing module, the image of the object captured by the second image capturing module and the distance between the first image capturing module and the second image capturing module measured by the distance measurement module.

11. The optical touch system of claim 10, wherein the control module is further for calculating the coordinate value of the object within the coordinate detecting area according to a first angle included between a line connecting the first image capturing module and the second image capturing module and a line connecting the first image capturing module and the object, a second angle included between a line connecting the first image capturing module and the second image capturing module and a line connecting the second image capturing module and the object and the distance between the first image capturing module and the second image capturing module measured by the distance measurement module.

12. The optical touch system of claim 11, wherein a first directional component of the coordinate value of the object within the coordinate detecting area is (the distance between the first image capturing module and the second image capturing module)*(tan(the second angle))/(tan(the first angle)+tan(the second angle)), and a second directional component of the coordinate value of the object within the coordinate detecting area is (the first directional component)*tan(the first angle).

13. The optical touch system of claim 10, wherein the control module is further for determining an intensity of the light emitted by the at least one light source according to the distance between the first image capturing module and the second image capturing module, a maximum distance between the first image capturing module and the second image capturing module, a minimum distance between the first image capturing module and the second image capturing module, a maximum intensity required by the first image capturing module and the second image capturing module as being located by the maximum distance therebetween and a minimum intensity required by the first image capturing module and the second image capturing module as being located by the minimum distance therebetween.

14. The optical touch system of claim 13, wherein the intensity of the light emitted by the at least one light source is (the minimum intensity)+[((the distance between the first image capturing module and the second image capturing module)−(the minimum distance))*(the maximum intensity−the minimum intensity)/(the maximum distance−the minimum distance)].

15. An image processing method for an optical touch device, comprising:
at least one light source of the optical touch device emitting light to illuminate an object;
a first image capturing module and a second image capturing module respectively capturing images of the object, wherein a relative position between the first image capturing module and the second image capturing module is adjustable; and
a control module of the optical touch device calculating a coordinate value of the object according to the images of the object captured by the first image capturing module and the second image capturing module, and the relative position between the first image capturing module and the second image capturing module.

16. The image processing method of claim 15, further comprising a distance measurement module measuring a distance between the first image capturing module and the second image capturing module, and the control module of the optical touch device calculating the coordinate value of the object according to the images of the object captured by the first image capturing module and the second image capturing module, and the relative position between the first image capturing module and the second image capturing module comprising the control module of the optical touch device calculating the coordinate value of the object according to the images of the object captured by the first image capturing module and the second image capturing module, and the distance between the first image capturing module and the second image capturing module measured by the distance measurement module.

17. The image processing method of claim 16, wherein the control module of the optical touch device calculating the coordinate value of the object according to the images of the object captured by the first image capturing module and the second image capturing module, and the distance between the first image capturing module and the second image capturing module measured by the distance measurement module comprises:
the control module calculating the coordinate value of the object within the coordinate detecting area according to a first angle included between a line connecting the first image capturing module and the second image capturing module and a line connecting the first image capturing module and the object, a second angle included between a line connecting the first image capturing module and the second image capturing module and a line connecting the second image capturing module and the object and the distance between the first image capturing module and the second image capturing module measured by the distance measurement module.

18. The image processing method of claim 17, wherein a first directional component of the coordinate value of the object within the coordinate detecting area is (the distance between the first image capturing module and the second image capturing module)*(tan(the second angle))/(tan(the first angle)+tan(the second angle)), and a second directional component of the coordinate value of the object within the coordinate detecting area is (the first directional component)*tan(the first angle).

19. The image processing method of claim 16, further comprising the control module further determining an intensity of the light emitted by the at least one light source according to the distance between the first image capturing module and the second image capturing module, a maximum distance between the first image capturing module and the second image capturing module, a minimum distance between the first image capturing module and the second image capturing module, a maximum intensity required by the first image capturing module and the second image capturing module as being located by the maximum distance therebetween and a minimum intensity required by the first image capturing module and the second image capturing module as being located by the minimum distance therebetween.

20. The image processing method of claim 19, wherein the intensity of the light emitted by the at least one light source is (the minimum intensity)+[((the distance between the first image capturing module and the second image capturing module)−(the minimum distance))*(the maximum intensity−the minimum intensity)/(the maximum distance−the minimum distance)].
